(19) United States
(12) Patent Application Publication
(10) Pub. No.: US 2019/0344825 A1
(43) Pub. Date: Nov. 14, 2019

(54) POWER STEERING ADJUSTMENT DEVICE AND POWER STEERING ADJUSTMENT METHOD

(71) Applicant: Mitsubishi Electric Corporation, Tokyo (JP)

(72) Inventors: Yoshimichi UMEKI, Tokyo (JP); Reiko SAKATA, Tokyo (JP)

(73) Assignee: Mitsubishi Electric Corporation, Tokyo (JP)

(21) Appl. No.: 16/473,911

(22) PCT Filed: Jan. 16, 2017
(86) PCT No.: PCT/JP2017/001248

§ 371 Date: Jun. 26, 2019

(51) Int. Cl. B62D 6/00; B62D 5/04

(52) U.S. Cl. CPC B62D 6/008; B62D 5/0457

(57) ABSTRACT

A guide setting unit (3) sets guide information including an editing object for a graph of steering control information; and limit information for limiting an edit operation performed on the editing object to an edit range allowed as the graph. A display processing unit (2) performs a process of displaying an editing screen including the graph and the guide information. An input processing unit (1) accepts an edit operation in accordance with the guide information. A graph editing unit (4) edits the graph within the edit range indicated by the limit information, in accordance with the edit operation accepted by the input processing unit (1).

### TECHNICAL FIELD

The present invention relates to a power steering adjustment device and a power steering adjustment method which are used to adjust electric power steering (hereinafter, described as EPS).

### BACKGROUND ART

The EPS transmits power of an assist motor to a steering system of a vehicle to reduce steering force required when a driver performs steering.

For example, Patent Literature 1 describes a steering characteristic setting device for an EPS which is improved such that steering characteristics can be edited on the basis of driver's personal preferences. The device displays a steering characteristic map on a display device, and edits the steering characteristic map on the basis of edit information inputted using a group of operating switches. The EPS assists steering operation on the basis of the steering characteristic map edited by the device.

### CITATION LIST

### Patent Literatures

Patent Literature 1: JP 2002-293257 A

### SUMMARY OF INVENTION

### Technical Problem

Patent Literature 1 does not indicate to what degree editing is required for the steering characteristic map to obtain a steering characteristic map that gives a targeted steering feeling. Hence, the steering characteristic setting device for the EPS described in Patent Literature 1 has a problem that when an edit operation deviates from an appropriate edit range allowed as a steering characteristic map, it takes a long time to edit the map to be a shape that gives a target steering feeling. This tendency gets more pronounced for people who are unaccustomed to adjusting EPS.

The present invention is made to solve the above-described problem, and an object of the invention is to obtain a power steering adjustment device and a power steering adjustment method that can perform an edit without deviating from an edit range allowed as a graph of steering control information.

### Solution to Problem

A power steering adjustment device according to the present invention includes a guide setting unit, a display processing unit, an input processing unit, and a graph editing unit. The guide setting unit sets guide information including an editing object for a graph of steering control information used when assist force of steering is adjusted; and limit information for limiting an edit operation performed on the editing object to an edit range allowed as the graph. The display processing unit performs a process of displaying an editing screen including the graph and the guide information. The input processing unit accepts an edit operation in accordance with the guide information. The graph editing unit edits the graph within the edit range indicated by the limit information, in accordance with the edit operation accepted by the input processing unit.

### Advantageous Effects of Invention

According to the present invention, guide information is set, the guide information including an editing object of a graph of steering control information; and limit information for limiting an edit operation performed on the editing object within an edit range allowed as the graph. Since the graph is edited within the edit range indicated by the limit information, an edit can be performed without deviating from the edit range allowed as the graph of steering control information.

### BRIEF DESCRIPTION OF DRAWINGS

FIG. 1 is a block diagram showing a configuration of a power steering adjustment device according to a first embodiment of the invention;

FIG. 2 is a flowchart showing operation of the power steering adjustment device according to the first embodiment;

FIG. 3A is a diagram showing an editing screen of a steering control information graph, and FIG. 3B is a diagram showing another example of an editing screen of a steering control information graph;

FIG. 4A is a diagram showing an outline of graph editing using edit points on the editing screen shown in FIG. 3A, and FIG. 4B is a diagram showing an outline of graph editing using edit points on the editing screen shown in FIG. 3B;

FIG. 5A is a diagram showing an outline of graph editing using handles and direction lines on the editing screen shown in FIG. 3A, and FIG. 5B is a diagram showing an outline of graph editing using handles and direction lines on the editing screen shown in FIG. 3B;

FIG. 6A is a diagram showing an outline of graph editing using handles and direction lines on the editing screen shown in FIG. 3A, and FIG. 6B is an enlarged view showing a portion enclosed by the rectangle shown in FIG. 6A;

FIG. 7A is a diagram showing a slider bar used to move an edit point, and FIG. 7B is a diagram showing slider bars used to change the slope and length of a direction line;

FIG. 8 is a flowchart showing a process of setting movable ranges of an edit point and a handle;

FIG. 9 is a diagram showing an example of a movable range of an edit point; and

FIG. 10 is a diagram showing an example of a movable range of a handle.

### DESCRIPTION OF EMBODIMENTS

To describe the present invention in more detail, some embodiments for carrying out the invention will be described below with reference to the accompanying drawings.

### First Embodiment

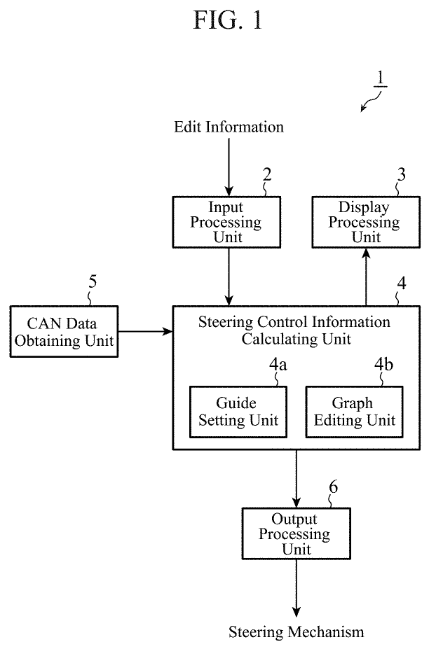

FIG. 1 is a block diagram showing a configuration of a power steering adjustment device 1 according to a first embodiment of the invention. The power steering adjustment device 1 adjusts an EPS mounted on a vehicle, and includes, as shown in FIG. 1, an input processing unit 2, a display processing unit 3, a steering control information calculating unit 4, a CAN data obtaining unit 5, and an output processing unit 6. The steering control information calculating unit 4 includes a guide setting unit 4a and a graph editing unit 4b.

The input processing unit 2 accepts an edit operation based on guide information. For example, the input processing unit 2 accepts, as an edit operation, a touch operation on a touch panel mounted on a screen of a display device. The display device and the touch panel may be included in an in-vehicle device such as an in-vehicle navigation device, or a display device and a touch panel that are included in an information terminal carried into the vehicle, such as a smartphone and a tablet terminal, may be used.

The display processing unit 3 displays, on the display device, an editing screen including: a graph of steering control information; and guide information. The steering control information is used when assist force of vehicle's steering is adjusted, and is represented by a single numerical value or array data of two or three variables. In the case of array data of two or three variables, the steering control information can be represented by two-dimensional or three-dimensional graphs.

The graph of steering control information includes, for example, control characteristic graphs indicating a relationship between a steering angle and a steering torque value, a relationship between reaction force received from a road surface and motor compensating current, a relationship between steering torque and motor compensating current, and a relationship among a steering angle, a steering torque value, and vehicle speed, respectively. In addition, the graph of steering control information includes control characteristic graphs indicating a relationship between reaction force received from a road surface, motor compensating current, and vehicle speed and a relationship between steering torque, motor compensating current, and vehicle speed, respectively.

The input processing unit 2 accepts an edit operation performed on the editing screen displayed on the display device.

In the above, a case in which the input processing unit 2 accepts a touch operation on a touch panel as an edit operation is shown. Alternatively, the input processing unit 2 may accept an edit operation performed by an input device which is provided separately from the touch panel. Such an input device includes, for example, a hard key and a mouse.

The steering control information calculating unit 4 calculates steering control information on the basis of CAN data inputted from the CAN data obtaining unit 5.

The car area network (CAN) data is, for example, data obtained from a steering mechanism of the vehicle in real time, and includes vehicle speed information and steering angle information.

The guide setting unit 4a sets guide information including editing objects and limit information.

The editing objects are objects serving as edit targets in edit of a graph of steering control information, such as edit points, direction lines, and handles.

An edit point is a point on a graph whose position can be changed by an edit operation, and the shape of the graph changes on the basis of the movement of the edit point. A direction line is a straight line extending from both sides or one side of an edit point, and a handle is an end point of a direction line extending from an edit point.

The limit information is used for limiting an edit operation performed on an editing object such that the steering control information is in an edit range allowed as a graph of steering control information, and includes, for example, a movable range of an edit point and a movable range of a handle of a direction line. The edit range allowed as a graph of steering control information is a range in which the shape of the graph falls within an appropriate shape as the graph of steering control information. The appropriate shape for a graph of steering control information is, for example, a graph shape of steering control information that gives a typical driver's steering feeling.

The limit information is displayed on the graph of steering control information by the display processing unit 3 together with the editing object.

The graph editing unit 4b edits the graph of steering control information within the edit range indicated by the limit information, on the basis of the edit operation accepted by the input processing unit 2. For example, the graph editing unit 4b changes the shape of the graph on the basis of the movement of an edit point, and changes the shape of the graph on the basis of changes in the slope and length of a direction line. When the shape of the graph is changed, the steering control information is also changed accordingly. As a result, a user can adjust the assist force of the EPS so as to match his/her steering feeling.

The graph editing unit 4b, for example, accepts movement of an edit point within a movable range shown on the graph of steering control information, and does not accept movement of the edit point that deviates from the movable range. As a result, even a person who is unaccustomed to adjusting EPS can perform an edit without deviating from an appropriate edit range allowed as a graph of steering control information.

The CAN data obtaining unit 5 obtains CAN data from the steering mechanism of the vehicle in real time. As described previously, the CAN data obtaining unit 5 obtains CAN data including vehicle speed information and steering angle information.

Note that although FIG. 1 shows a configuration in which the power steering adjustment device 1 includes the CAN data obtaining unit 5, no limitation thereto is intended. For example, the power steering adjustment device 1 may not include the CAN data obtaining unit 5, and the CAN data obtaining unit 5 may be included in the steering mechanism side.

The steering mechanism includes an assist motor and a control device that controls the assist motor.

The assist motor gives drive power for steering power assist, and the rotation of the assist motor is controlled by the above-described control device.

The output processing unit 6 outputs the steering control information calculated by the steering control information calculating unit 4 to the control device. The control device controls the rotation of the assist motor on the basis of the steering control information, and steering power assist is performed consequently.

Next, the operation will be described.

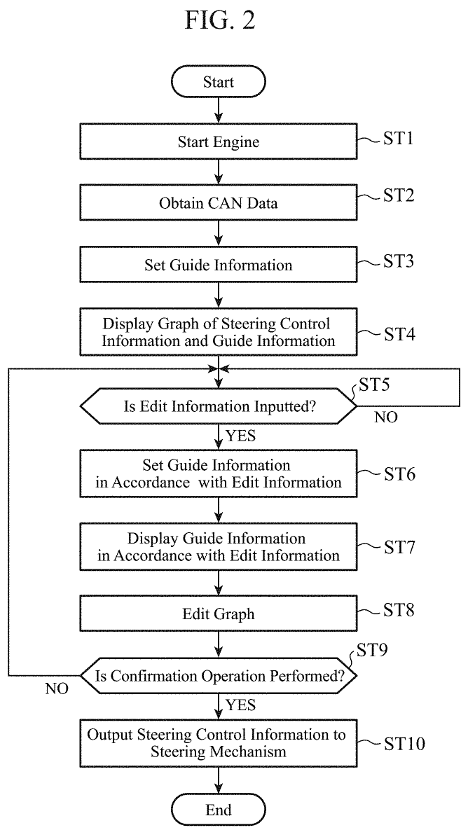

FIG. 2 is a flowchart showing the operation of the power steering adjustment device 1, and shows a power steering adjustment method according to the first embodiment.

First, when the vehicle engine starts (step ST1), the CAN data obtaining unit 5 obtains CAN data (step ST2). The CAN data obtained by the CAN data obtaining unit 5 is outputted in turn to the steering control information calculating unit 4.

The steering control information calculating unit 4 calculates steering control information on the basis of the inputted CAN data.

The guide setting unit 4a creates a graph of the steering control information, and sets guide information including edit points, direction lines, and handles which are editing objects of the graph (step ST3). The graph of the steering control information and the guide information are outputted to the display processing unit 3 from the guide setting unit 4a. The display processing unit 3 generates editing screen information including the steering control information graph and the edit points, the direction lines, and the handles, and displays the editing screen information by the display device (step ST4).

Then, the steering control information calculating unit 4 checks whether edit information is inputted from the input processing unit 2 (step ST5). The edit information indicates a content of a user's edit operation accepted by the input processing unit 2.

If edit information is not inputted (step ST5; NO), the process at step ST5 is repeated.

If edit information is inputted (step ST5; YES), the guide setting unit 4a sets guide information in accordance with the edit information (step ST6). The guide information in accordance with the edit information includes limit information for an edit operation performed on an editing object being an edit target.

The display processing unit 3 displays the guide information set by the guide setting unit 4a, on the display device (step ST7).

The graph editing unit 4b edits the graph of the steering control information, on the basis of the edit information (step ST8). When the graph editing unit 4b completes the editing of the graph on the basis of the edit information, the graph editing unit 4b checks whether a confirmation operation is performed (step ST9). The confirmation operation is an operation for confirming the content of editing of the graph and terminating the editing, and is, for example, an operation of pressing a confirm button which is not shown in the drawings.

If a confirmation operation is not performed (step ST9; NO), processing returns to step ST5, and the graph editing unit 4b becomes a state of waiting for input of edit information.

If a confirmation operation is performed (step ST9; YES), the graph editing unit 4b outputs steering control information represented by the graph which is a result of the editing to the output processing unit 6.

The output processing unit 6 outputs the steering information inputted from the graph editing unit 4b to the steering mechanism (step ST10).

Next, an outline of the graph editing at step ST8 will be described.

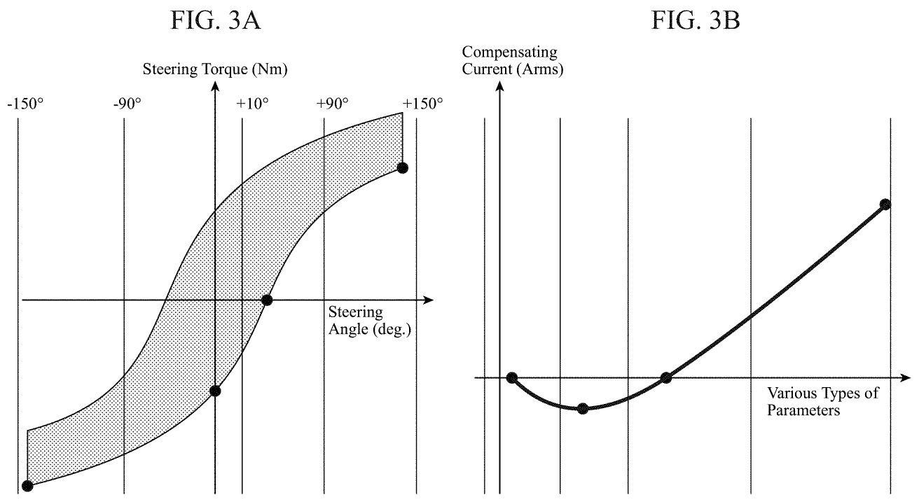

FIG. 3A is a diagram showing an editing screen of a steering control information graph, and shows a case in which edit points are displayed to be superimposed on a graph indicating a relationship between a steering angle and steering torque. FIG. 3B is a diagram showing another example of an editing screen of a steering control information graph, and shows a case in which edit points are displayed to be superimposed on a graph indicating a relationship between various types of parameters and compensating current.

The various types of parameters include parameters such as “reaction force received from a road surface” or “steering torque”. By summarizing a relationship between these parameters and compensating current, the graph representing a relationship between a steering angle and steering torque shown in FIG. 3A is calculated.

Although FIG. 3A shows a case in which the steering angle is in a range of −150° to +150°, the steering angle changes in accordance with the vehicle speed. For example, when the vehicle speed is 40 km/h, the steering angle is in a range of −120° to +120° , and when the vehicle speed is 20 km/h, the steering angle is in a range of −150° to +150°.

There are four edit points set for each of the graphs shown in FIGS. 3A and 3B, and the edit points shown in FIG. 3B correspond to the edit points shown in FIG. 3A.

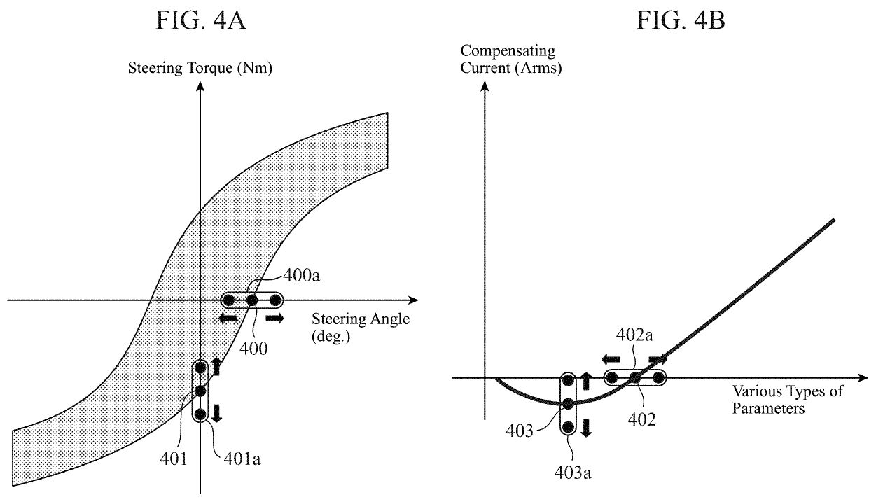

FIG. 4A is a diagram showing an outline of graph editing using edit points on the editing screen of FIG. 3A. FIG. 4B is a diagram showing an outline of graph editing using edit points on the editing screen of FIG. 3B. On the editing screen shown in FIG. 4A, the guide setting unit 4a sets a movable range 400a that limits a movable direction to the horizontal-axis direction and limits a moving range, for an edit point 400 present in a position in which the graph intersects the horizontal axis. Furthermore, the guide setting unit 4a sets a movable range 401a that limits a movable direction to the vertical-axis direction and limits a moving range, for an edit point 401 present in a position in which the graph intersects the vertical axis.

On the editing screen shown in FIG. 4B, the guide setting unit 4a sets a movable range 402a that limits a movable direction to the horizontal-axis direction and limits a moving range, for an edit point 402 present in a position in which the graph intersects the horizontal axis. Furthermore, the guide setting unit 4a sets a movable range 403a that limits a movable direction to the vertical-axis direction and limits a moving range, for an edit point 403 present in a position in which the graph intersects neither the horizontal axis nor the vertical axis.

The movable ranges 400a to 403a are set such that the shape of a graph that is changed by moving the edit points 400 to 403 falls within an appropriate shape as a graph of steering control information.

Note that an appropriate shape as a graph of steering control information is, as described previously, for example, a graph shape of steering control information that gives a typical driver's steering feeling.

When, among the edit points 400 to 403, for example, the edit point 400 is dragged, the movable range 400a is displayed to be superimposed on the graph. Namely, a movable range of the edit point that becomes an edit target is displayed. As such, since only the movable range of the edit point that becomes an edit target is displayed, bothersome screen display, in which many movable ranges are displayed when the graph is edited, can be avoided.

In addition, even if an edit operation for the edit points 400 to 403 to be deviated from the movable ranges 400a to 403a is performed, the graph editing unit 4b holds the edit points 400 to 403 at positions on a boundary of the movable ranges 400a to 403a.

The user can recognize the movable ranges of the edit points 400 to 403 from the movable ranges 400a to 403a on the editing screen, and can edit the graph without deviating from the movable ranges 400a to 403a.

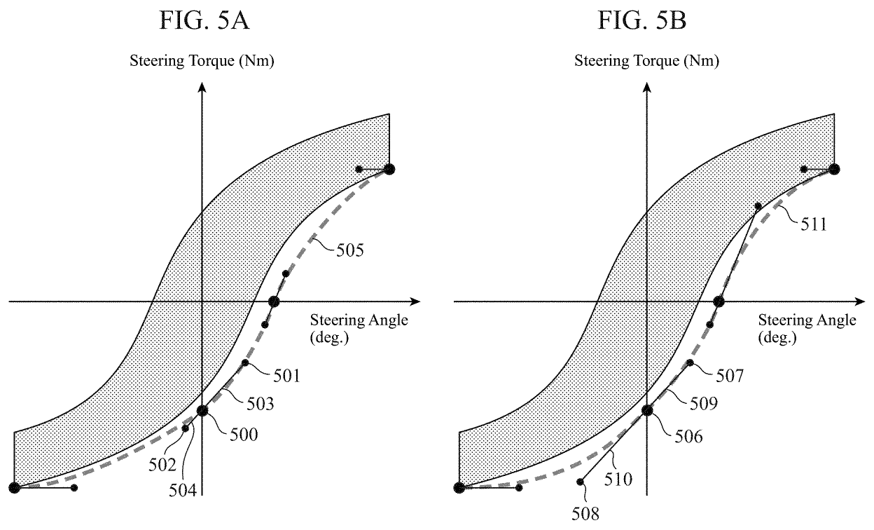

FIG. 5A is a diagram showing an outline of graph editing using handles and direction lines on the editing screen of FIG. 3A, and shows a case in which direction lines and handles are displayed to be superimposed on the graph, in addition to edit points. FIG. 5B is a diagram showing an outline of graph editing using handles and direction lines on the editing screen of FIG. 3B, and shows a case in which direction lines and handles are displayed to be superimposed on the graph, in addition to edit points. On the editing screen shown in FIG. 5A, the guide setting unit 4a sets an edit point 500, handles 501 and 502, and direction lines 503 and 504. The handle 501 is arranged on one side of the edit point 500, and the direction line 503 is a line segment connecting the edit point 500 and the handle 501. The handle 502 is arranged on the other side of the edit point 500, and the direction line 504 is a line segment connecting the edit point 500 and the handle 502.

When the handles 501 and 502 move, the slopes and lengths of the direction lines 503 and 504 change in accordance with the positions of the handles 501 and 502. When the slopes and lengths of the direction lines 503 and 504 change, the shape of a curve passing through the edit point 500 changes as indicated by a dashed-line curve 505 in FIG. 5A. The curve 505 is an approximate curve which passes through the edit point and in which its curve portion between handles on both sides of the edit point is approximated by a straight line along direction lines. By performing editing to obtain the above-described approximate curve on each of adjacent edit points, in curve portions forming the shape of the graph, a bulge of the curve portion between edit points is edited.

On the editing screen shown in FIG. 5B, the guide setting unit 4a sets an edit point 506, handles 507 and 508, and direction lines 509 and 510.

The handle 507 is arranged on one side of the edit point 506, and the direction line 509 is a line segment connecting the edit point 506 and the handle 507. The handle 508 is arranged on the other side of the edit point 506, and the direction line 510 is a line segment connecting the edit point 506 and the handle 508.

When the handles 507 and 508 move, the slopes and lengths of the direction lines 509 and 510 change in accordance with the positions of the handles 507 and 508. When the slopes and lengths of the direction lines 509 and 510 change, the shape of a curve passing through the edit point 506 changes as indicated by a dashed-line curve 511 in FIG. 5B. The curve 511 is an approximate curve which passes through an edit point and in which its curve portion between handles on both sides of the edit point is approximated by a straight line along direction lines. By performing the editing to obtain the above-described approximate curve on each of adjacent edit points, in curve portions forming the shape of the graph, a bulge of the curve portion between edit points is edited.

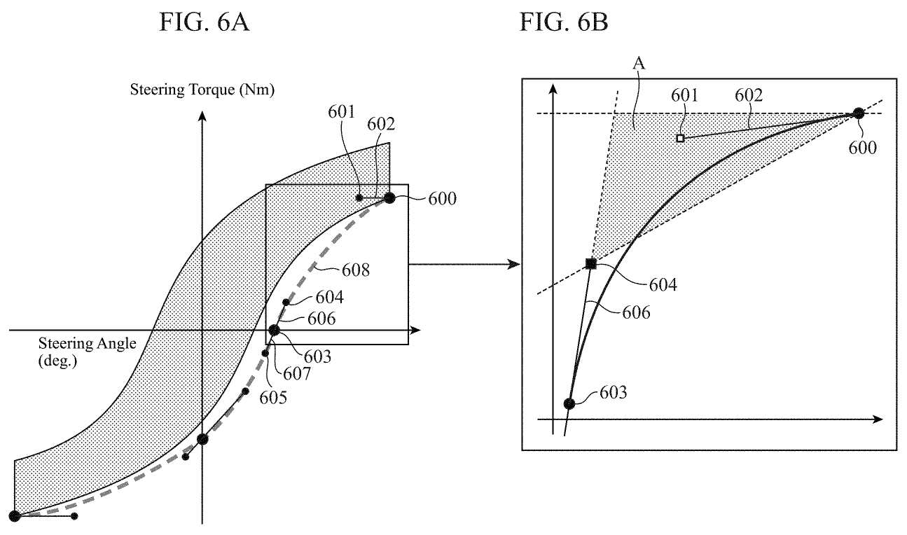

FIG. 6A is a diagram showing an outline of graph editing using handles and direction lines on the editing screen shown in FIG. 3A. FIG. 6B is an enlarged view showing a portion enclosed by a rectangle shown in FIG. 6A.

On the editing screen shown in FIG. 6A, the guide setting unit 4a sets an edit point 600, a direction line 602 extending from the edit point 600, and a handle 601 which is an end point of the direction line 602, and sets an edit point 603 and direction lines 606 and 607 extending from both sides of the edit point 603, respectively.

When the handles 601, 604, and 605 move, the slopes and lengths of the direction lines 602, 606, and 607 change. When the slopes and lengths of the direction lines 602, 606, and 607 change, the shape of a curve of the graph passing through the edit points 600 and 603 changes as indicated by a dashed-line curve 608 in FIG. 6A.

The editable ranges of the slopes and lengths of the direction lines 602, 606, and 607 are set such that the shape of the graph that is changed in accordance with the editing of the slopes and lengths of the direction lines 602, 606, and 607 falls within an appropriate shape as a graph of steering control information.

The appropriate shape as a graph of steering control information is, as described previously, for example, a graph shape of steering control information that gives a typical driver's steering feeling.

When, among the handles 601, 604, and 605, the handle 601 is dragged, a movable range A shown in FIG. 6B is displayed to be superimposed on the graph. The display is performed in a mode in which the movable range A is highlighted, for example, before and after dragging the handle 601, the color of the movable range A changes, the luminance of the movable range A changes, or the boundary line of the movable range A becomes a thick line.

As such, since only the movable range of a handle that is set to be an edit target is highlighted, bothersome screen display, in which many movable ranges are displayed to be highlighted in the same manner when the graph is edited, can be avoided.

In addition, even if an edit operation for the handle 601 to be deviated from the movable range A is performed, the graph editing unit 4b holds the handle 601 at a position on a boundary of the movable range A.

The user can recognize the movable range of the handle 601 from the movable range A on the editing screen, and can edit the graph without deviating from the movable range A.

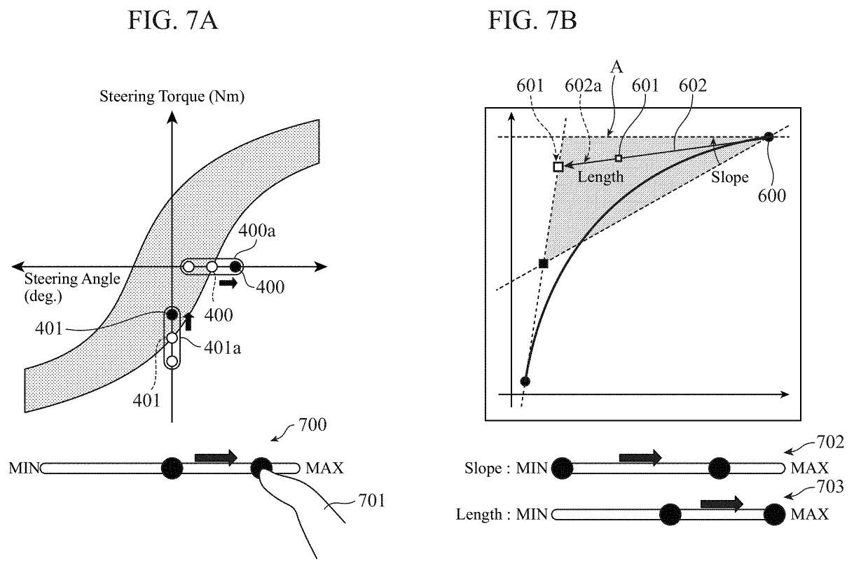

FIG. 7A is a diagram showing a slider bar 700 used to move an edit point 400 or an edit point 401 by an edit operation. FIG. 7B is a diagram showing slider bars 702 and 703 used to change the slope and length of the direction line 602 by an edit operation. On an editing screen shown in FIG. 7A, the guide setting unit 4a sets the slider bar 700 used to move the edit point 400 or the edit point 401.

For example, when the edit point 400 is dragged and becomes an edit target, a movable range 400a is displayed on the graph. When the slider bar 700 is slid with a finger 701, the edit point 400 gradually moves as indicated by an arrow in FIG. 7A. Then, when the slider bar 700 is slid to a maximum position, the edit point 400 moves to a maximum movable position of the movable range 400a.

When the edit point 401 is dragged and becomes an edit target, a movable range 401a is displayed on the graph. When a sliding operation is performed on the slider bar 700, the edit point 401 moves. When the slider bar 700 is slid to the maximum position, the edit point 401 moves to a maximum movable position of the movable range 401a.

On an editing screen shown in FIG. 7B, the guide setting unit 4a sets the slider bars 702 and 703 used to edit the slope and length of the direction line 602, i.e., move the handle 601 of the direction line 602. When the handle 601 is dragged and becomes an edit target, the movable range A is displayed on the graph.

When the slider bar 702 is slid, the handle 601 rotates about the edit point 600 and the slope of the direction line 602 changes. When the slider bar 703 is slid, the handle 601 moves in a direction of the direction line 602 and the length of the direction line 602 changes. For example, when the slider bar 703 is slid to a maximum position, the handle 601 moves to a boundary position of the movable range A, and accordingly, the direction line extends and becomes a direction line 602a. As such, by using the slider bars, it becomes possible to more easily edit the graph.

Next, a process of setting movable ranges of an edit point and a handle will be described.

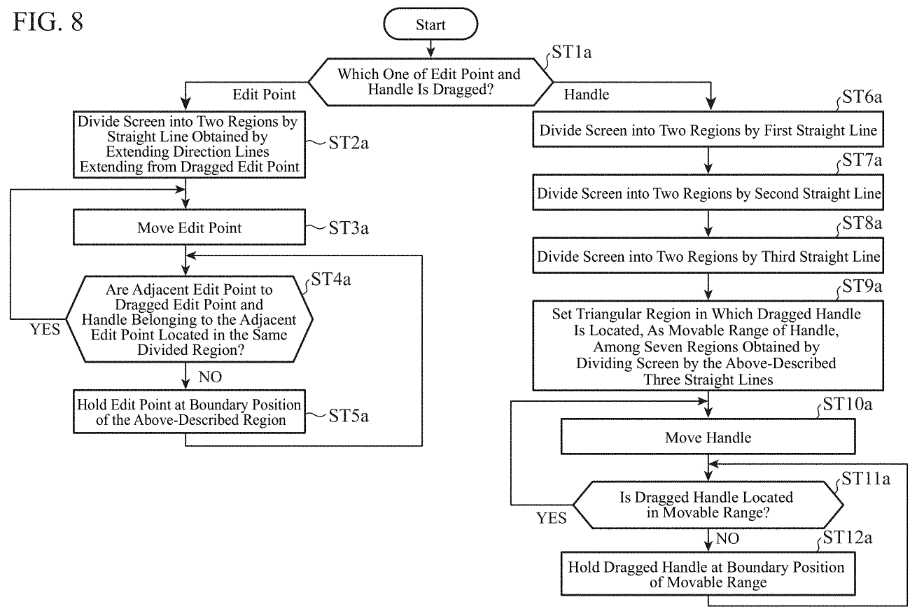

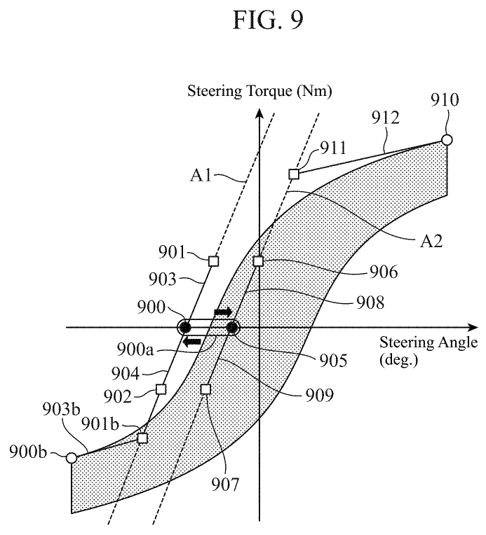

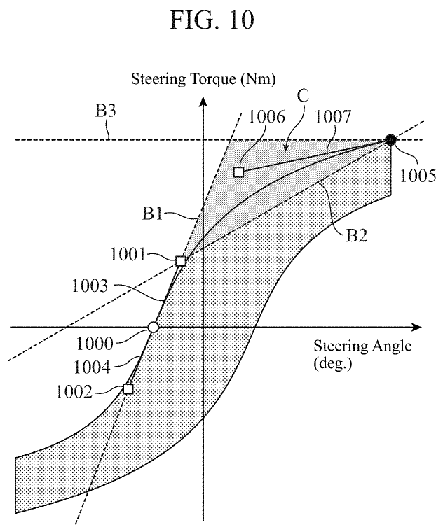

FIG. 8 is a flowchart showing a process of setting movable ranges of an edit point and a handle, and shows the details of a process of setting limit information in the process at step ST6 of FIG. 2. FIG. 9 is a diagram showing an example of a movable range of an edit point. FIG. 10 is a diagram showing an example of a movable range of a handle.

The guide setting unit 4a checks which one of an edit point and a handle displayed to be superimposed on the graph on the editing screen is a dragged editing object (step ST1a).

If an edit point is dragged in an edit operation (step ST1a; the edit point), the guide setting unit 4a divides the editing screen into two regions by a straight line obtained by further extending direction lines extending from the edit point (step ST2a). For example, in FIG. 9, handles 901 and 902 are provided on both sides of an edit point 900, a line segment connecting the edit point 900 and the handle 901 is a direction line 903, and a line segment connecting the edit point 900 and the handle 902 is a direction line 904. When the edit point 900 is dragged and becomes an edit target, the guide setting unit 4a divides the editing screen into two regions by a straight line Al obtained by extending the direction lines 903 and 904.

The graph editing unit 4b moves the edit point 900 in accordance with the amount of dragging (step ST3a). The graph editing unit 4b checks whether an adjacent edit point to the dragged edit point and a handle belonging to the adjacent edit point are located in a divided region on the same side which is divided at step ST2a (step ST4a).

In the example of FIG. 9, it is checked whether an adjacent edit point 900b to the dragged edit point 900 and a handle 901b of a direction line 903b extending from the edit point 900b are located in a divided region on the same side which is divided with respect to the straight line A1.

If an adjacent edit point to the dragged edit point and a handle belonging to adjacent the edit point are located in a divided region on the same side (step ST4a; YES), the dragged edit point is located in a movable range. In this case, the graph editing unit 4b returns to the process at step ST3a and continues the movement of the edit point. By this processing, the edit point 900 moves within a movable range 900a.

If an adjacent edit point to the dragged edit point and a handle belonging to the adjacent edit point deviate from a divided region on the same side (step ST4a; NO), the graph editing unit 4b holds the edit point at a boundary position of the movable range (step ST5a). Thereafter, processing returns to the process at step ST4a.

For example, when the edit point 900 moves by dragging and becomes an edit point 905, the guide setting unit 4a divides the editing screen into two regions by a straight line A2 obtained by extending direction lines 908 and 909 extending from the edit point 905. An adjacent edit point 910 to the edit point 905 and a handle 911 belonging to the adjacent edit point 910 are located in a divided region on the same side.

However, when the edit point 905 further moves in a horizontal-axis direction, the handle 911 deviates from a divided region in which the edit point 905 and handles 906 and 907 belonging to the edit point 905 are located, out of the two regions divided with respect to the straight line A2.

In order to prevent the occurrence of deviation of the handle 911, when the edit point 900 becomes an edit target, the guide setting unit 4a sets the movable range 900a with the position of the edit point 905 being a maximum movable position. By this setting, even if dragging is performed to further move the edit point 905 in a lateral direction, the graph editing unit 4b holds the edit point at an end of the movable range 900a shown in FIG. 9.

It is required for edit points on a graph of steering control information to monotonously increase with respect to the vertical and horizontal axes. To meet this requirement, an adjacent edit point to a dragged edit point and a handle belonging to the adjacent edit point need to be located in a divided region on the same side on an editing screen which is divided into two regions with respect to a straight line obtained by extending direction lines extending from the dragged edit point. The guide setting unit 4a sets a movable range of an edit point that meets the requirement, and thereby sets an appropriate edit range allowed as a graph of steering control information.

On the other hand, if a handle is dragged in an edit operation (step ST1a; the handle), the guide setting unit 4a divides the editing screen into two regions with respect to a first straight line B1 (step ST6a). In FIG. 10, the first straight line B1 is obtained by extending direction lines 1003 and 1004 extending from an edit point 1000 which is closest to an edit-target handle 1006 out of edit points adjacent to an edit point 1005 to which a direction line 1007 passing through the edit-target handle 1006 is connected.

Then, the guide setting unit 4a divides the editing screen into two regions with respect to a second straight line B2 (step ST7a). In FIG. 10, the second straight line B2 is obtained by extending a line segment connecting the edit point 1005 to which the direction line 1007 having the edit-target handle 1006 is connected, and a handle 1001 of the direction line 1003 extending from the edit point 1000 which is closest to the edit-target handle 1006.

Then, the guide setting unit 4a divides the editing screen into two regions with respect to a third straight line B3 (step ST8a). In FIG. 10, the third straight line B3 passes through the edit point 1005 to which the direction line 1007 having the edit-target handle 1006 is connected, and is parallel to the horizontal axis of the graph.

The guide setting unit 4a sets a triangular region in which the edit-target handle is located, as a movable range of the handle, among seven divided regions on the editing screen divided with respect to each of the first straight line B1, the second straight line B2, and the third straight line B3 (step ST9a).

In FIG. 10, the region in which the edit-target handle 1006 is located is set as a movable range C of the handle 1006.

The graph editing unit 4b moves the handle 1006 in accordance with the amount of dragging (step ST10a). The graph editing unit 4b checks whether the edit-target handle 1006 is located in the movable range C (step ST11a).

If the edit-target handle 1006 is located in the movable range C (step ST11a; YES), the graph editing unit 4b returns to the process at step ST10a and continues the movement of the handle 1006. If the dragged handle 1006 deviates from the movable range C (step ST11a; NO), the graph editing unit 4b holds the handle 1006 at a boundary position of the movable range C (step ST12a). Thereafter, processing returns to step ST11a.

As described previously, it is required for edit points on a graph of steering control information to monotonously increase with respect to the vertical and horizontal axes. To meet the requirement, an edit-target handle needs to be present in the above-described triangular region. Hence, the guide setting unit 4a sets a movable range of a handle that meets the requirement, and thereby sets an appropriate edit range allowed as a graph of steering control information.

As described above, the power steering adjustment device 1 according to the first embodiment sets guide information including: an editing object in a graph of steering control information; and limit information for limiting an edit operation performed on the editing object to an edit range allowed as the graph.

In particular, the guide setting unit 4a sets an edit point, a direction line, and a handle as editing objects, and sets a movable range of the edit point and a movable range of the handle as limit information. Since the graph is edited within an edit range indicated by the limit information, an edit can be performed without deviating from the edit range allowed as the graph.

In the power steering adjustment device 1 according to the first embodiment, the guide setting unit 4a sets, as editing objects, the slider bars 700, 702, and 703 for editing that accept movement of an edit point and changes in the slope and length of a direction line in accordance with sliding operation. The display processing unit 3 performs a process of displaying an editing screen including the slider bars 700, 702, and 703 which are set by the guide setting unit 4a. The input processing unit 2 accepts movement of the edit point and changes in the slope and length of the direction line using the slider bars 700, 702, and 703.

By such a configuration, the user can easily perform graph editing.

In the power steering adjustment device 1 according to the first embodiment, the guide setting unit 4a divides the editing screen into two regions with respect to the straight line Al which is obtained by extending the direction lines 903 and 904 extending from the edit-target edit point 900. Then, the guide setting unit 4a sets the movable range 900a of the edit point 900 such that the adjacent edit point 900b to the edit-target edit point 900 and the handle 901b belonging to the adjacent edit point 900b are located in a divided region on the same side on the editing screen.

By this, the edit range of the edit point 900 can be appropriately set.

In the power steering adjustment device 1 according to the first embodiment, the guide setting unit 4a divides the editing screen with respect to each of the first straight line B1, the second straight line B2, and the third straight line B3. The guide setting unit 4a sets the region in which the edit-target handle 1006 is present, as the movable range C of the edit-target handle, among a plurality of divided regions on the editing screen.

The first straight line B1 is obtained by extending the direction line 1003 extending from the edit point 1000 which is closest to the handle 1006 out of edit points adjacent to the edit point 1005 to which the direction line 1007 having the edit-target handle 1006 is connected. The second straight line B2 is obtained by extending a line segment connecting the edit point 1005 to which the direction line 1007 having the edit-target handle 1006 is connected, and the handle 1001 of the direction line 1003 extending from the edit point 1000 which is closest to the handle 1006. The third straight line B3 passes through the edit point 1005 to which the direction line 1007 having the edit-target handle 1006 is connected, and is parallel to the vertical or horizontal axis of the graph.

By this, the edit range of the handle 1006 can be appropriately set.

Note that in the present invention, modifications of any component of embodiments or omissions of any component of embodiments are possible within the scope of the invention.

### INDUSTRIAL APPLICABILITY

A power steering adjustment device according to the present invention can edit a graph of steering control information without deviating from an edit range allowed as the graph, and thus is suitable for adjustment of steering control of a vehicle.

### REFERENCE SIGNS LIST

1: Power steering adjustment device, 2: Input processing unit, 3: Display processing unit, 4: Steering control information calculating unit, 4a: Guide setting unit, 4b: Graph editing unit, 5: CAN data obtaining unit, 6: Output processing unit, 400 to 403, 500, 506, 600, 603, 900, 900b, 905, 910, 1000, and 1005: Edit point, 400a to 403a and 900a: Movable range, 501, 502, 507, 508, 601, 604, 605, 901, 901b, 902, 906, 907, 911, 1001, and 1006: Handle, 503, 504, 509, 510, 602, 602a, 606, 607, 903, 903b, 904, 908, 909, 1003, 1004, and 1007: Direction line, 505 and 511: Curve, 700, 702, and 703: Slider bar, and 701: Finger.

1. A power steering adjustment device comprising:
a guide setter setting guide information including: an editing object for a graph of steering control information used when assist force of steering is adjusted; and limit information for limiting an edit operation performed on the editing object to an edit range allowed as the graph;
a display processor performing a process of displaying an editing screen including the graph and the guide information;
an input processor accepting an edit operation in accordance with the guide information; and
a graph editor editing the graph within the edit range indicated by the limit information, in accordance with the edit operation accepted by the input processor.

2. The power steering adjustment device according to claim 1, wherein the guide setter:
sets, as the editing object, an edit point being a point on the graph and a shape of the graph being changed in accordance with movement of the edit point, and a direction line whose slope and length change in accordance with movement of an end point of the direction line, the direction line extending from the edit point and the shape of the graph changing in accordance with the change in the slope and length of the direction line, and
sets, as the limit information, a movable range of the edit point and a movable range of the end point of the direction line.

3. The power steering adjustment device according to claim 2, wherein
the guide setter sets, as the editing object, slider bars for editing for accepting movement of the edit point and changes in the slope and length of the direction line, in accordance with sliding operation of the slider bars,
the display processor performs a process of displaying the editing screen including the slider bars set by the guide setter, and
the input processor accepts the movement of the edit point and the changes in the slope and length of the direction line using the slider bars.

4. The power steering adjustment device according to claim 2, wherein the guide setter divides the editing screen into two regions with respect to a straight line obtained by extending the direction line extending from the edit point being an edit-target, and sets the movable range of the edit point such that an adjacent edit point to the edit point being an edit-target and an end point of a direction line extending from the adjacent edit point are located in a divided region on a same side on the editing screen with respect to the straight line.

5. The power steering adjustment device according to claim 2, wherein the guide setter:
divides the editing screen into a plurality of divided regions with respect to each of
a first straight line obtained by extending a direction line extending from an edit point closest to the end point being an edit-target among adjacent edit points to an edit point to which a direction line including the edit-target end point is connected,
a second straight line obtained by extending a line segment connecting the edit point to which the direction line including the end point being the edit-target is connected, and an end point of the direction line extending from the edit point closest to the end point being the edit-target, and
a third straight line that passes through the edit point to which the direction line including the end point being the edit-target is connected, and that is parallel to a vertical axis or a horizontal axis of the graph, and
sets a region in which the end point being the edit-target is present, as a movable range of the end point being the edit-target, among the plurality of divided regions on the editing screen.

6. A power steering adjustment method comprising:
displaying guide information including an editing object for a graph of steering control information used when assist force of steering is adjusted; and limit information for limiting an edit operation performed on the editing object to an edit range allowed as the graph;
accepting an edit operation in accordance with the guide information; and
editing the graph within the edit range indicated by the limit information, in accordance with the accepted edit operation.
